(19) United States
(12) Patent Application Publication
(10) Pub. No.: US 2016/0360749 A1
(43) Pub. Date: Dec. 15, 2016

(54) METHOD FOR MITIGATING MICROBIAL INFLUENCED CORROSION

(71) Applicant: ExxonMobil Research and Engineering Company, Annandale, NJ (US)

(72) Inventors: Kuang He, Annandale, NJ (US); Giovanni Pilloni, Jersey City, NJ (US)

(21) Appl. No.: 15/157,790

(22) Filed: May 18, 2016

Related U.S. Application Data
(60) Provisional application No. 62/174,611, filed on Jun. 12, 2015.

(51) Int. Cl. A01N 43/38; C23F 11/06; C23F 11/04

(52) U.S. Cl. CPC A01N 43/38; C23F 11/04; C23F 11/06

(57) ABSTRACT

Provided are methods for mitigating or eliminating Microbial Influenced Corrosion of a metal surface including contacting the metal surface with an effective amount of a liquid composition comprising indole or a functionally equivalent analog or derivative thereof. Also provided are methods for reducing the formation or activity of a corrosion-associated biofilm on a metal surface including contacting the metal surface with an effective amount of a liquid composition including indole or a functionally equivalent analog or derivative thereof.

### CROSS-REFERENCE TO RELATED APPLICATIONS

This application claims priority to U.S. Provisional Application Ser. No. 62/174,611 filed Jun. 12, 2015, which is herein incorporated by reference in its entirety.

### FIELD

This disclosure generally relates to an effective and cost-effective solution to solve the problem of microbial influenced corrosion (“MIC”) of solid surfaces, such as the equipment used by the petroleum and natural gas industries to store, transport, and process raw materials such as oil and gas. More specifically, this disclosure relates to methods and compositions for preventing and/or mitigating the formation of harmful biofilms associated with microbial influenced corrosion on susceptible metal surfaces of oil and gas production, storage, and transport equipment by contacting said equipment with indole and/or a functionally equivalent analog or derivative thereof.

### BACKGROUND

Microbial influenced corrosion (“MIC”) poses severe operational, environmental, and safety problems to the petroleum and/or natural gas industries, particularly with respect to corrosion of equipment used in the storage, processing, and/or transport of oil and gas crude and/or processed materials. Costs resulting from MIC in these industries due to repair and replacement of damaged equipment, spoiled oil, environmental clean-up, and injury-related health care, amount to well over several billion USD per year.

The mechanisms by which microbial influenced corrosion causes damage are poorly understood despite many decades of research. See Kwan Li et al., “Beating the bugs: Roles of microbial biofilms in corrosion, Corrosion Reviews,” Vol. 31, Issue 3-6, December 2013, pp. 73-84 (the contents of which are incorporated by reference). However, it is believed that microbial influenced corrosion is primarily caused by the formation of microbial biofilms on equipment metal surfaces that come into contact with crude oil and gas and/or the liquid systems involved in their refinery.

The microorganisms thought to be primarily responsible for corrosion at least in an anaerobic environment within the oil industry are sulfate-reducing bacteria. Other culpable bacteria include iron oxidizing bacteria, sulfur oxidizing bacteria, nitrate reducing bacteria, methanogens, and acid producing bacteria, among others. These categories of bacteria generally are capable of reducing metal directly, producing metabolic products that are corrosive (e.g., hydrogen sulfide gas), and/or leading to the formation of biofilms that indirectly alter the local environment to promote corrosion. See N. Muthukumar et al., “Microbiologically influenced corrosion in petroleum product pipelines—A Review,” Indian Journal of Experimental Biology, Vol. 41, September 2003, pp. 1012-1022.

Sulfate-reducing bacteria, in particular, are ubiquitous and can grow in almost any environment. They are routinely found in ⁻waters associated with oil production systems and can be found in virtually all industrial aqueous processes, including cooling water systems and petroleum refining. Sulfate-reducing bacteria require an anaerobic (oxygen-free) aqueous solution containing adequate nutrients, an electron donor, and electron acceptor. A typical electron acceptor is sulfate, which produces hydrogen sulfide upon reduction. Hydrogen sulfide is a highly corrosive gas and reacts with metal surfaces to form insoluble iron sulfide corrosion products. In addition, hydrogen sulfide partitions into the water, oil, and natural gas phases of produced fluids and creates a number of serious problems. For instance, “sour” oil and gas, which contains high levels of hydrogen sulfide, have a lower commercial value than low sulfide oil and gas. Removing biogenic hydrogen sulfide from sour oil and gas increases the cost of these products. It is also an extremely toxic gas and is immediately lethal to humans at even small concentrations. Thus, its presence in the oil field poses a threat to worker safety.

Corrosion—often characterized in association with pitting of metal surfaces—caused by sulfate-reducing bacteria frequently results in extensive damage to oil and gas storage, production, and transportation equipment. Pipe systems, tank bottoms, and other pieces of oil production equipment can rapidly fail if there are areas where microbial corrosion is occurring. If a failure occurs in a pipeline or oil storage tank bottom, the released oil can have serious environmental consequences. Also, if a failure occurs in a high pressure water or gas line, the consequences may be worker injury or death. Any failure at least involves repair or replacement costs.

A variety of strategies have been developed to mitigate the corrosive effects of MIC and/or the biofilms that contribute or cause MIC. Such techniques include the use of corrosion-resistant metals, temperature control, pH control, radiation, filtration, protective coatings with corrosion inhibitors or other chemical controls (e.g., biocides, oxidizers, acids, alkalis), bacteriological controls (e.g., phages, enzymes, parasitic bacteria, antibodies, competitive microflora), pigging (i.e., mechanical delamination of corrosion products), anodic and cathodic protection, and modulation of nutrient levels. However, each of these existing methods face obstacles, such as, high cost, lack of effectiveness, short life-span, or requirement for repeat applications. For example, regular biocide injections are only effective sometimes and only in particular environments. In addition, biocides often fail due to incompatibility with other commonly used corrosion inhibitors and because of biofilm permeability issues, i.e., the biocides are unable to penetrate or permeate the biofilms due to the properties of the extracellular matrix of the biofilm. Also, many of the above controls are not practical for implementing in the oil field due to the potential effect on the downstream processes.

Pigging and biocide are the most commonly used approaches for controlling biofilm and corrosion in the oil field. Pigging is required to remove or disrupt the biofilm on the pipe surfaces. Pigging can also remove many of the harmful iron sulfide deposits. While pigging will be substantially effective where thick biofilms are present, thin biofilms and thin iron sulfide deposits are not appreciably affected by the scraping action of pigs. Subsequently, biocides and surfactant-biocide treatments are used extensively to control bacterial activity oil field systems. However, biocides are not typically effective in penetrating the biofilms, and therefore, have reduced effectiveness against the underlying bacteria. Combination treatments in conjunction with pigging are more effective than the chemical treatments alone. However, treatments must be made routinely on a fixed schedule or else the bacteria population increases significantly and control becomes even more difficult.

Thus, there exists a need in the art for an improved approach for inhibiting microbial influenced corrosion that avoids the above-indicated problems associated with existing methods, and in particular, which effectively reduces, mitigates, or otherwise eliminates corrosion-associated biofilms on oil and gas refinery equipment.

### SUMMARY

This disclosure relates, in part, to the surprising and unexpected discovery that indole and compounds that are functionally equivalent to indole significantly reduce anaerobic biofilms on surfaces, and consequently, may be used to reduce, mitigate, or eliminate Microbial Influenced Corrosion (MIC) on metal surfaces, and in particular, metal surfaces on equipment involved in the storage, transport, and refinery in the petrochemical and natural gas industries. In particular embodiments, the indole was surprisingly effective in reducing, eliminating, or blocking biofilm formation in anaerobic environments, which prior to the invention was not known or appreciated. Such equipment can include pipeline, storage tanks, and refinery processing equipment. In certain embodiments, indole-based treatments can also be combined with existing microbial corrosion mitigation techniques, such as pigging and corrosion inhibitors. However, the indole-based methodologies herein disclosed are advantageous over existing mitigation practices at least because: (a) indole is a natural product of environmental bacteria, hence minimal environmental impact compared to traditional biocides; (b) biocides are naturally taken up by bacteria in a biofilm to induce a switch to planktonic growth behavior (i.e., growth away from biofilm environment) and thus, lack the poor biofilm permeability aspects of biocides; and (c) indole is compatible with other commercial corrosion inhibitors, whereas many biocides are not.

In one aspect, the disclosure relates to a method for mitigating or eliminating Microbial Influenced Corrosion of a metal surface comprising contacting the metal surface with an effective amount of a liquid composition comprising indole or a functionally equivalent analog or derivative thereof.

In another aspect, the disclosure relates to a method for reducing or preventing the formation or activity of a corrosion-associated biofilm on a metal surface comprising contacting the metal surface with an effective amount of a liquid composition comprising indole or a functionally equivalent analog or derivative thereof.

In still another aspect, the disclosure discloses compositions, e.g., liquid formulations, comprising indole and which are effective in reducing or preventing the formation or corrosive properties of corrosion-associated biofilms, particularly in anaerobic environments. The compositions disclosed in certain embodiments comprise an effective amount of indole or a functionally equivalent analog or derivative thereof that can be used to introduce into affected oil and/or gas refinery equipment for reducing or preventing the formation or activity of a corrosion-associated biofilm.

In certain embodiments, the Microbial Influenced Corrosion is caused by a bacterial biofilm deposited on the surface of the metal surface.

In other embodiments, the bacterial biofilm is formed by anaerobic bacteria.

In still other embodiments, the bacterial biofilm is formed by aerobic bacteria.

In certain embodiments, the anaerobic bacteria are selected from the group consisting of sulfate reducing bacteria, iron oxidizing bacteria, sulfur oxidizing bacteria, nitrate reducing bacteria, methanogens, and acid producing bacteria. The sulfate reducing bacteria can be of the genera Desulfovibrio, Desulfotomaculum, Desulfosporomusa, Desulfosporosinus, Desulfobacter, Desulfobacterium, Desulfobacula, Desulfobotulus, Desulfocella, Desulfococcus, Desulfofaba, Desulfofrigus, Desulfonema, Desulfosarcina, Desulfospira, Desulfotalea, Desulfotignum, Desulfobulbus, Desulfocapsa, Desulfofustis, Desulforhopalis, Desulfoarculus, Desulfobacca, Desulfomonile, Desulfotigmum, Desulfohalobium, Desulfomonas, Desulfonatronovibrio, Desulfomicrobium, Desulfonatronum, Desulfacinum, Desulforhabdus, Syntrophobacter, Syntrophothermus, Thermaerobacter, and Thermodesulforhabdus.

In various embodiments, the susceptible metal surface that is treated is a metal surface of equipment for refining, storing, or transporting of crude or processed oil or gas, and can include, for example, metal (e.g., steel) pipelines, storage containers, or refinery processing equipment.

In certain embodiments, the liquid composition comprising indole or a functionally equivalent analog or derivative thereof can be an aqueous composition.

In certain embodiments, the liquid composition comprising indole or a functionally equivalent analog or derivative thereof can be a non-aqueous composition.

In still other embodiments, the liquid composition comprising indole or a functionally equivalent analog or derivative thereof can have an acidic pH, ranging from about 6.0-7.0, to about 5.5-6.5, to about 4.5-5.5, to about 3.5-4.5, to about 2.5-3.5, to about 1.5-2.5, or lower than 1.5.

In still other embodiments, the liquid composition comprising indole or a functionally equivalent analog or derivative thereof can have a basic pH, ranging from about 7.0-7,5, to about 7.5-8,5, to about 8,5-9,5, to about 9.5-1.0.5, to about 10.5-11.5, to about 11.5-12.5, to about 12.5-13.5 to about 14.

In still other embodiments, the liquid composition comprising indole or a functionally equivalent analog or derivative thereof can have a neutral pH, ranging from about 6-8, or about 6.5-7.5, or about 6.7-7.3, or about 6.8-7.2, or about 6.9-7.1, or about 7.

In certain other embodiments, the pH of the aqueous environment surrounding or at the metal surface to be treated can be adjusted with buffers or other pH-altering agents to adjust the pH to any basic, neutral, or acidic conditions.

In still other embodiments, the liquid composition comprising indole or a functionally equivalent analog or derivative thereof comprises at least one other inhibitor of Microbial Influenced Corrosion. Such other inhibitors can be a biocide selected from the group consisting of germicides, antibiotics, antibacterials, antivirals, antifungals, antiprotozoals and antiparasites.

In other embodiments, the indole treatment method may include or involve a secondary or co-treatment for mitigating or eliminating Microbial Influenced Corrosion of the metal surface selected from the group consisting of pigging, radiation treatment, pH adjustment, nutrient adjustment, and installation of corrosion-resistant metals.

In various embodiments, the effective amount of the liquid composition comprising indole or a functionally equivalent analog or derivative thereof provides a concentration of indole that is between about 50-500 micromolar, about 0.5-1.0 mM, about 1.0 mM-5 mM, about 2.5 mM-10 mM, about 5 mM-25 mM, about 10 mM-100 mM, or about 50 mM-1000 mM.

Where applicable or not specifically disclaimed, any one of the embodiments described herein are contemplated to be able to combine with any other one or more embodiments, even though the embodiments are described under different aspects of the disclosure. These and other embodiments are disclosed or are obvious from and encompassed by, the following Detailed Description, including the Drawings and Examples herein.

### BRIEF DESCRIPTION OF THE DRAWINGS

The following detailed description, given by way of example, but not intended to limit the disclosure solely to the specific embodiments described, may best be understood in conjunction with the accompanying drawings.

FIG. 1 provides a bar graph based on Example 1 which shows that indole specifically targets and reduces Microbial Influenced Corrosion.

FIG. 2A provides a bar graph based on. Example 2 which demonstrates that indole inhibits corrosion of metal caused by biofilms formed by Desulfovibrio vulgaris Hildenborough (DvH) as a representative sulfate reducing bacterium. FIG. 2B provides a bar graph based on Example 2, showing that bacterial metabolism is unaffected by the addition of indole in the growth media.

### DETAILED DESCRIPTION

### Overview

Microbial Influenced Corrosion (“MIC”)—at term of art—is frequently observed at oil production sites and in transport pipelines, among other types of equipment involved in the oil production industry. MIC poses severe operational, environmental, and safety problems to the petroleum and/or natural gas industries, particularly with respect to corrosion of equipment used in the storage, processing, and/or transport of oil and gas crude and/or processed materials. Costs resulting from MIC in these industries due to repair and replacement of damaged equipment, spoiled oil, environmental clean-up, and injury-related health care, amount to well over several billion USD per year. Biofilms that form on the surfaces of such metal components are thought to be the primary causative agent triggering such corrosion as many biofilm forming environmental bacteria-particularly those in anaerobic environments-produce harmful gases (e.g., hydrogen sulfide), acids (e.g., sulfuric acid), and other agents which are highly corrosive and also which poses health and safety concerns to those workers in the industry. Current mitigation techniques to reduce microbial-induced corrosion are available, but are not effective enough and/or are not practical in the industry due to high cost and other reasons. For example, the use of biocides is common, but their effectiveness is limited due to inability to permeate the corrosive biofilms.

The disclosure relates, in part, to the surprising and unexpected discovery that indole and compounds that are functionally equivalent to indole significantly reduces the formation of biofilms on surfaces, and consequently, may be used to reduce, mitigate, or eliminate Microbial Influenced Corrosion on metal surfaces, and in particular, metal surfaces on equipment involved in the storage, transport, and refinery in the petrochemical and natural gas industries. In particular embodiments, the indole was surprisingly effective in reducing, eliminating, or blocking biofilm formation in anaerobic environments, which prior to the disclosure was not known or appreciated. Such equipment can include pipeline, storage tanks, and refinery processing equipment. In certain embodiments, indole-based treatments can also be combined with existing microbial corrosion mitigation techniques, such as pigging and corrosion inhibitors. However, the indole-based methodologies herein disclosed are advantageous over existing mitigation practices at least because: (a) indole is a natural product of environmental bacteria, hence minimal environmental impact compared to traditional biocides; (b) indole is naturally taken up by bacteria in a biofilm to induce a switch to planktonic growth behavior (i.e., growth away from biofilm environment) and thus, lack the poor biofilm permeability aspects of biocides; and (c) indole is compatible with other commercial corrosion inhibitors, whereas many biocides are not.

The following is a detailed description of the disclosure provided to aid those skilled in the art in practicing the present disclosure. Those of ordinary skill in the art may make modifications and variations in the embodiments described herein without departing from the spirit or scope of the present disclosure. Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure. All publications, patent applications, patents, figures and other references mentioned herein are expressly incorporated by reference in their entirety.

Although any methods and materials similar or equivalent to those described herein can also be used in the practice or testing of the present disclosure, the preferred methods and materials are now described. All publications mentioned herein are incorporated herein by reference to disclose and described the methods and/or materials in connection with which the publications are cited.

### Definitions

Unless defined otherwise, all technical and scientific terms used herein have the meaning commonly understood by a person skilled in the art to which this disclosure belongs. The following references, the entire disclosures of which are incorporated herein by reference, provide one of skill with a general definition of many of the terms (unless defined otherwise herein) used in this disclosure: Singleton et al., Dictionary of Microbiology and Molecular Biology (2^{nd} ed. 1994); The Cambridge Dictionary of Science and Technology (Walker ed., 1988); The Glossary of Genetics, 5^{th} Ed., R. Rieger et al. (eds.), Springer Verlag (1991); and Hale & Marham, the Harper Collins Dictionary of Biology (1991). Generally, the procedures of molecular biology methods described or inherent herein and the like are common methods used in the art. Such standard techniques can be found in reference manuals such as for example Sambrook et al., (2000, Molecular Cloning—A Laboratory Manual, Third Edition, Cold Spring Harbor Laboratories); and Ausubel et al., (1994, Current Protocols in Molecular Biology, John Wiley & Sons, New-York).

The following terms may have meanings ascribed to them below, unless specified otherwise. However, it should be understood that other meanings that are known or understood by those having ordinary skill in the art are also possible, and within the scope of the present disclosure. All publications, patent applications, patents, and other references mentioned herein are incorporated by reference in their entirety. In the case of conflict, the present disclosure, including definitions, will control. In addition, the materials, methods, and examples are illustrative only and not intended to be limiting.

All numerical values within the detailed description and the claims herein are modified by “about” or “approximately” the indicated value, and take into account experimental error and variations that would be expected by a person having ordinary skill in the art,

As used herein, the singular forms “a”, “and”, and “the” include plural references unless the context clearly dictates otherwise. All technical and scientific terms used herein have the same meaning.

As used herein, the term “biocide” refers to a chemical substance or microorganism which can deter, render harmless, or exert a controlling effect on any harmful organism by chemical or biological means. Biocides include those that are synthetic, but also those which are naturally obtained, e.g., obtained or derived from bacteria and plants. Biocides can include, but are not limited to, germicides, antibiotics, antibacterials, antivirals, antifungals, antiprotozoals and antiparasites. Such compounds are well-known in the art and may be obtained easily from commercial sources. Reference may be made to the biocides disclosed in the book Corrosion in the Petrochemical Industry. Ed. Linda Garverick, ASM International, 1994, the contents of which are incorporated herein by reference.

As used herein, the term “Microbial Influenced Corrosion” or “MIC” or similar terms are terms in the art and shall be understood according to the meaning ascribed in the field, i.e., corrosion to metal surfaces caused directly or indirectly through the effects of bacteria and their by-products and metabolites at metal surfaces, including especially bacteria that grow on the surface of metal in a biofilm. MIC can occur in both aerobic and anaerobic conditions and generally is thought to at least require the presence of bacteria in a biofilm. MIC is considered “biotic corrosion.” MIC is also associated with surface pitting, which leads to more rapid corrosive failure than uniform corrosion.

As used herein, the term “sulfate reducing bacteria” or “SRB,” which are considered one of the main culprits of biotic corrosion in anaerobic conditions, are a grouping of bacteria that includes at least 220 species which produce H₂S, and use sulfates as the terminal electron acceptor. Most SRB are considered obligate anaerobes, meaning that the cells cannot metabolize and/or replicate in the presence of oxygen, although many species can temporarily tolerate low levels of oxygen. Furthermore, anaerobic conditions capable of supporting SRB growth can be created in overall aerobic environments, due to the microniches created within the bacterial biofilm/corrosion product layer. Although SRB are the most studied and well understood of the anaerobic corrosion inducing bacteria, MIC can occur in anaerobic conditions in the absence of SRB.

As used herein, the term “corrosion-associated biofilms” refer to biofilms that have corrosive properties which contribute to Microbial Influenced Corrosion.

As used herein, the term “pigging” refers to the well-known process of intentional mechanical delamination of corrosion products and biofilm material from the surfaces of metals.

As used herein, the term. “corrosion” refers to the general deterioration of a material (e.g., metallic material) due to its reaction with the environment.

As used herein, the term “indole” refers to the naturally occurring aromatic heterocyclic organic compound consisting of a six-membered benzene ring fused to a five-membered nitrogen-containing pyrrole ring, as shown in the following structure:

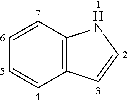

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein can be modified by the term about.

Any compositions or methods provided herein can be combined with one or more of any of the other compositions and methods provided herein.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

Reference will now be made in detail to exemplary embodiments of the disclosure. While the disclosure will be described in conjunction with the exemplary embodiments, it will be understood that it is not intended to limit the disclosure to those embodiments. To the contrary, it is intended to cover alternatives, modifications, and equivalents as may be included within the spirit and scope of the disclosure as defined by the appended claims.

Exemplary compositions and methods of the present disclosure are described in more detail in the following sections: (C) Indole compositions; (D) Biofilms and treatable surfaces; (E) Treatment methods/applications; and (F) Combination treatments,

### Indole Compositions

The disclosure provides for indole-containing compositions that may be administered to treatable or surfaces in need of treatment for the effective mitigation and/or elimination of biofilms, and particularly, biofilms in anaerobic conditions.

Without being bound by theory, the present inventors have surprisingly discovered that indole and compounds that are functionally equivalent to indole significantly reduce the formation of biofilms on surfaces, and consequently, may be used to reduce, mitigate, or eliminate Microbial Influenced Corrosion on metal surfaces, and in particular, metal surfaces on equipment involved in the storage, transport, and refinery in the petrochemical and natural gas industries,

In particular embodiments, the indole was surprisingly effective in reducing, eliminating, or blocking biofilm formation in anaerobic environments, which prior to the disclosure was not known or appreciated. Such equipment can include pipeline, storage tanks, and refinery processing equipment. In certain embodiments, indole-based treatments can also be combined with existing microbial corrosion mitigation techniques, such as pigging and corrosion inhibitors. However, the indole-based methodologies herein disclosed are advantageous over existing mitigation practices at least because: (a) indole is a natural product of environmental bacteria, hence minimal environmental impact compared to traditional biocides; (b) biocides are naturally taken up by bacteria in a biofilm to induce a switch to planktonic growth behavior(i.e., growth away from biofilm environment) and thus, lack the poor biofilm permeability aspects of biocides; and (c) indole is compatible with other commercial corrosion inhibitors, whereas many biocides are not.

Indole is a naturally occurring aromatic heterocyclic organic compound consisting of a six-membered benzene ring fused to a five-membered nitrogen-containing pyrrole ring, as shown in the following structure:

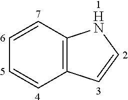

Indole is widely distributed in the natural environment and can be produced by a variety of bacteria and thus, can be obtained from nature. As an intercellular signal molecule, indole regulates various aspects of bacterial physiology. The amino acid tryptophan is an indole derivative and the precursor of the neurotransmitter serotonin. Indole is a solid at room temperature. Indole can be produced by bacteria as a degradation product of the amino acid tryptophan. It occurs naturally in human feces and has an intense fecal odor. At very low concentrations, however, it has a flowery smell, and is a constituent of many flower scents (such as orange blossoms) and perfumes. It also occurs in coal tar.

Indole and its derivatives can be obtained commercially from a wide range of sources that will be known the skilled artisan. Indole can also be synthesized by a variety of methods.

The main industrial route starts from aniline via vapor-phase reaction with ethylene glycol in the presence of catalysts:

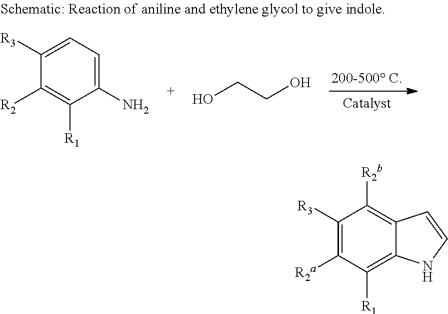

In general, reactions are conducted between 200 and 500° C. Yields can be as high as 60%. Other precursors to indole include formyltoluidine, 2-ethylaniline, and 2-(2-nitrophenyl)ethanol, all of which undergo cyclizations. Many other methods have been developed that are applicable.

The disclosed methods also contemplate the use of indole analogs or equivalent compounds. As used herein, “indole equivalent” or “indole analog or functionally equivalent compound, molecule or derivative” or similar terms includes any known or yet unknown compound that has a structure that is similar to indole (or that includes one or more indole subunits) to a degree such that is produces the same or similar biological effects of indole. Such analogs or functionally equivalent compounds may be obtained in various ways, including isolation from nature, chemical modification of indole, or via chemical synthesis. The indole equivalent compound should bear at least 70%, or more preferably 75%, or even more preferably 85%, or 90%, or 95%, or 100% of the biological activity of indole. Indole analogs are well known and widely available, for example, see Timothy Barden, “Indoles: Industrial, Agricultural and Over-the-Counter Uses,” Top Heterocycl Chem (2011) 26: 31-46, which is incorporated herein by reference.

The indole compositions for use in the disclosed methods can be prepared to have any useful properties that may be appropriate or advantageous to the particular surface to be treated, the exact composition of which will depend on various factors that include whether the surface to be treated is under aerobic or anaerobic conditions, the pH and salinity of the surface to be treated, the consortium or population characteristics of the bacteria present in the biofilm of the target surface to be treated, the properties of the biofilm to be treated, among other characteristics.

The indole compositions can also include other components that help stabilize and/or improve the indole as the active ingredient, or which facilitate its delivery. For example, the compositions herein described may also include surfactants or disruption agents and the like which increase the permeability and/or disruption of the biofilm to facilitate the movement of the indole into the biofilm and come into contact with the bacteria therein. Surfactants are well known in the art and include anionic surfactants (e.g., ammonium lauryl sulfate, sodium lauryl sulfate (SDS, sodium dodecyl sulfate, another name for the compound), sodium lauryl ether sulfate (SLES), and sodium myreth sulfate; sodium stearate, sodium lauroyl sarcosinate), cationic surfactants (Octenidine dihydrochloride, Cetylpyridinium chloride (CPC), Benzalkonium chloride (BAC), Benzethonium chloride (BZT), 5-Bromo-5-nitro-1,3-dioxane, Dimethyldioctadecylammonium chloride, Cetrimonium bromide, Dioctadecyldimethylammonium bromide (DODAB)), and nonionic surfactants (Polyoxyethylene glycol alkyl ethers, Polyoxypropylene glycol alkyl ethers, Glucoside alkyl ethers, Polyoxyethylene glycol octylphenol ethers (e.g., Triton-X), Polyoxyethylene glycol alkylphenol ethers, Glycerol alkyl esters, Polyoxyethylene glycol sorbitan alkyl esters, Polyethoxylated tallow amine (POEA)), as well as biosurfactants (surface-active substances synthesised by living cells).

The indole-containing compositions suitable for use in the disclosed methods may include any suitable amount of indole or indole analog/equivalent. For example, compositions may be formulated in aqueous solutions having a concentration of between about 1%-5% indole, or between about 2.5%-40%, or between about 5%-15%, or between about 10%-25%, or between about 15%-50%, or between about 20%-75% or more. Preferably, the concentration of the indole or indole analog/equivalent is about 5%, or preferably about 10%, or preferably about 20%, or preferably less than 50%. The skilled person will be able to determine the necessary and/or desired concentration.

When administering the indole-containing composition to a site targeted for treatment (i.e., a. surface having MIC), the composition is administered or delivered in an amount or dosage sufficient to provide an effective amount of the indole or indole analog. As used herein, the term “effective amount of the indole or indole analog” is the minimal amount, level, or concentration of indole or indole analog which results in a measurable or detectable effect on the MIC or on the associated biofilm itself. The effective amount can be measured in terms of concentration as parts-per-million (ppm). In certain embodiments, the effective amount will be at least 0.05 ppm, or at least 0.5 ppm, or at least 1 ppm, or at least 2 ppm, or at least 4 ppm, or at least 10 ppm, or at least 15 ppm, or at least 20 ppm, or at least 20 ppm, or at least 25 ppm, or at least 50 ppm, or at least 100 ppm, or at least 1000 ppm or more.

### Biofilms and Treatable Surfaces

Without being bound by theory, the present inventors have surprisingly discovery that indole and compounds that are functionally equivalent to indole significantly reduce the formation of biofilms on surfaces, and consequently, may be used to reduce, mitigate, or eliminate Microbial Influenced Corrosion on metal surfaces, and in particular, metal surfaces on equipment involved in the storage, transport, and refinery in the petrochemical and natural gas industries.

It will be appreciated that microorganisms present in aqueous environments form biofilms on solid surfaces. Biofilm consists of populations of microorganisms and their hydrated polymeric secretions. Numerous types of organisms may exist in any particular biofilm, ranging from strictly aerobic bacteria at the water interface to anaerobic bacteria such as sulphate reducing bacteria (SRB) at the oxygen depleted metal surface. Biofilm formation is thought to follow a multi-series of specific steps that include: (a) an initial bacterial attachment stage that is rapid and reversible; (b) a longer term attachment stage; (c) a replication phase; (d) a polysaccharide-rich matrix secretion stage; (e) a biofilm maturation stage; and (f) finally bacterial dispersal stage. Biofilms can be microns to millimeters to centimeters or more in thickness and can develop over the course of hours, day, or months, depending on many factors that include the consortium of bacteria present and the environment. Biofilms are highly complex naturally occurring biotic structures having a wide range of characteristics and their exact role in corrosion is still under intense study. However, biofilm-associated corrosion is at least a function of the composition of the underlying bacterial population that forms the biofilm and on the environment. See Kwan Li et al.

The presence of biofilm can contribute to corrosion in at least three ways: (1) physical deposition, (2) production of corrosive by-products, and (3) deplorization of the corrosion cell caused by chemical reaction.

Many of the byproducts of microbial metabolism including organic acids and hydrogen sulphide are corrosive. These materials can concentrate in the biofilm causing accelerated metal attack. Corrosion tends to be self-limited due to the build-up of corrosion reaction products. However, microbes can absorb some of these materials in their metabolism, thereby removing them from the anodic and cathodic sites. The removal of reaction products, termed depolarization, stimulates further corrosion.

Biofilms are usually found on solid substrates submerged in or exposed to an aqueous solution, although they can form as floating mats on liquid surfaces and also on the surface of leaves, particularly in high humidity climates. Given sufficient resources for growth, a biofilm will quickly grow to be macroscopic (visible to the naked eye). Biofilms can contain many different types of microorganism, e.g., bacteria, archaea, protozoa, fungi and algae; each group performs specialized metabolic functions. However, some organisms will form single-species films under certain conditions. The social structure (cooperation, competition) within a biofilm highly depends on the different species present.

Biofilms are held together and protected by a matrix of secreted polymeric compounds called EPS. EPS is an abbreviation for either extracellular polymeric substance or exopolysaccharide, although the latter one only refers to the polysaccharide moiety of EPS. In fact, the EPS matrix consists not only of polysaccharides but also of proteins (which may be the major component in environmental and waste water biofilms) and nucleic acids. A large proportion of the EPS is more or less strongly hydrated, however, hydrophobic EPS also occur; one example is cellulose which is produced by a range of microorganisms. This matrix encases the cells within it and facilitates communication among them through biochemical signals as well as gene exchange. The EPS matrix is an important key to the evolutionary success of biofilms and their resistance to, in this case, biocides and other chemical treatments to remove them. One reason is that it traps extracellular enzymes and keeps them in close proximity to the cells. Thus, the matrix represents an external digestion system and allows for stable synergistic microconsortia of different species (Wingender and Flemming, Nat. Rev. Microbiol. 8, 623-633). Some biofilms have been found to contain water channels that help distribute nutrients and signaling molecules.

Despite these protective physical and biological properties of biofilms—and in particular, the EPS which presents a significant permeability barrier to anti-bacterial agents—indole (and indole analogs) has been shown by the inventors to be effective in mitigating the formation of biofilms on metal surfaces, in particular, under anaerobic conditions.

The indole-based compositions of the disclosure can be used to treat any affected surface, and in particular, any affected metal surface on any equipment involved in the storage, transport, and/or refinery of petroleum and/or natural gas products. For example, affected surfaces can include pipeline that transports crude oil from onshore or offshore drill site or from hydraulic fracturing sites to local or distant petroleum and/or natural gas refineries. Problematic biofilms can form along the interior surfaces of pipelines over distances that extend over many miles or tens of miles, leading to corrosive conditions over a multitude of points. It is generally accepted that pipeline corrosion represents the majority of corrosive damage due to MIC in the oil and gas industries, particularly given that there are over 190,000 miles of liquid pipelines in the US alone. In another example, affected surfaces can include oil storage facilities at refinery sites or those located on oil transport tankers. Other equipment, such as pumps, valves, and other equipment that comes into contact with the oil flow path is susceptible to the formation of biofilms and thus to MIC. Any and all of these sites and surfaces may be treated using the methods disclosed herein.

### Treatment Methods/Applications

In one aspect, the disclosure relates to a method for mitigating or eliminating Microbial Influenced Corrosion of a metal surface comprising contacting the metal surface with an effective amount of a liquid composition comprising indole or a functionally equivalent analog or derivative thereof. In another aspect, the disclosure relates to a method for reducing or preventing the formation or activity of a corrosion-associated biofilm on a metal surface comprising contacting the metal surface with an effective amount of a liquid composition comprising indole or a functionally equivalent analog or derivative thereof.

The methods disclosed herein may also include additional upstream and/or downstream testing steps that facilitate knowing whether and how to administer the indole-based treatment. Such additional steps may aim to determine whether a target system has a legitimate MIC risk at a particular site (e.g., crude pipeline that transports crude oil from an offshore rig to a distant domestic refinery). Other steps may also involve subsequent monitoring steps to evaluate the extent of the MIC associated biofilm., and followed then by steps to carry out a particular indole-related treatment plan, e.g., an aggressive treatment plan or a lower-strength treatment plan.

For example, corrosive damage to a pipeline might be detected as a result of regularly scheduled maintenance along a certain ten-mile stretch of crude oil pipeline. In order to learn more about the extent and nature of the damage, and therefore, an appropriate treatment, a user might sample the environmental conditions at various points along the pipeline by assessing properties that would be indicative of conditions suitable for biofilm formation, such as, (a) detection of certain bacterial species known to have a role in bacterial corrosion (e.g., sulfate reducing bacteria), (b) detection of certain corrosive metabolites (e.g., presence of organic acids, hydrogen sulfide gas, (c) existence of suitable pH and temperature conditions known to be supportive of biofilm development, (d) presence of an aqueous environment (e.g., extent of water drop-out or separation of a water phase from the crude oil), (e) slow flow rate (slower flow rates are conducive to biofilm formation), and (f) existence of high bacterial biomass. The skilled person may also wish to examine physical samples collected from the pipeline wall to detect and characterize the biofilm (e.g., thickness) or metal coupon samples placed into the flow path. Such factors can be evaluated and then assessed by the skilled person to design a specifically tailored indole-based treatment.

In some embodiments, variables affecting the specific nature of any given indole-based treatment can include, for example: (a) pH of the indole composition, (b) salinity of the indole composition, (c) concentration of the indole in the composition (e.g., 1%, 2%, 5%, 10%, 50%, w/v), (d) target or desired concentration of the indole once delivered in the flow path (e.g., 1 ppm, 2 ppm, 4 ppm, 10 ppm, 50 ppm, 100 ppm, 500 ppm, 1000 ppm or more), (e) the rate of crude oil flow, (f) the rate of injection of the indol composition, (g) the types of bacteria present in the consortium of the biofilm, (h) the level of bacterial biomass and/or biofilm present, (i) the presence of visible evidence of corrosion (e.g., pits) (which generally is associated with the degree of corrosion in an increasing linear relationship), (j) and the detection of metal loss on test coupons. Each of these factors can be assessed, along with other available factors, to gauge the severity of the MIC risk and/or the degree of biofilm-associated corrosion. Once the severity of the corrosion is known, the skilled person can determine the best course for administering the treatment (i.e., the indole composition).

Treatment may be aggressive in nature, or otherwise less aggressive, depending on the degree and severity of the MIC and/or biofilm formation. For example, if the degree of biofilm-associated corrosion is determined to be low, a gentle treatment may be administered by, for example, reducing the total amount or concentration of indole delivered, reducing the number of hours of continued injection into the site of interest, or increasing the number of days spanning between follow-up injections. However, if the degree of biofilm-associated corrosion is determined to be high, a more aggressive treatment may be administered by, for example, increasing the total amount or concentration of indole delivered, increasing the time period for continuous injection, or shortening the number of time or days between successive treatments.

The skilled person will easily be able to assess the degree of biofilm-associated corrosion based on various measurable inputs and accordingly determine a proper course of indole treatment without undue experimentation.

### Combination Treatments

The disclosed indole treatment methods are also contemplated to be combined with other MIC-mitigation strategies, such as the use of corrosion-resistant metals, temperature control, pH control, radiation, filtration, protective coatings with corrosion inhibitors or other chemical controls (e.g., biocides, oxidizers, acids, alkalis), bacteriological controls (e.g., phages, enzymes, parasitic bacteria, antibodies, competitive microflora), pigging (i.e., mechanical delamination of corrosion products), anodic and cathodic protection, and modulation of nutrient levels.

In particular, in certain embodiments relating to pipeline treatment, the pipeline is first treated with pigging. The pigging can help not only to physically to remove the biofilm, but also acts to disturb the biofilm such that the permeation of the biofilm is improved, thereby rendering the indole treatment more effective.

Methods and equipment for pigging lines is well known in the art, and can be found described in the following US patents, each of which are incorporated by reference: U.S. Pat. Nos. 9,010,826; 8,858,732; 8,719,989; 7,739,767; 7,275,564; 6,874,757; 6,182,761; and 6,109,829.

This disclosure is further illustrated by the following examples which should not be construed as limiting. The contents of all references and published patents and patent applications cited throughout the application are hereby incorporated by reference.

### EXAMPLES

This disclosure is further illustrated by the following examples which should not be construed as limiting. The contents of all references, including any publicly available polypeptide and/or nucleic acid sequences accession numbers (e.g., GenBank), and published patents and patent applications cited throughout the application are hereby incorporated by reference. Those skilled in the art will recognize that the disclosure may be practiced with variations on the disclosed structures, materials, compositions and methods, and such variations are regarded as within the ambit of the disclosure.

### Example 1

### Reduction of MIC Associated with DvH Growing on Carbon Steel in the Presence of Indole

Carbon steel coupons were incubated in the presence of 0 and 2 mM indole, with and without an inoculum of DvH.

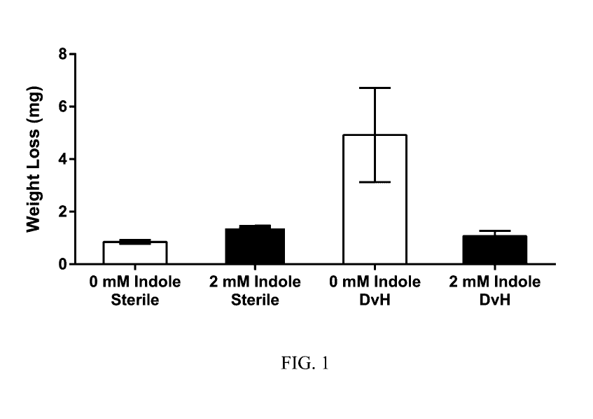

The metal loss of the carbon steel coupons was measured. FIG. 1 is a bar graph comparing corrosion as measured in coupon weight loss under the compound (indole) and SRB (DvH) tested. The results show that coupons incubated with DvH experienced approximately 2-fold more weight loss that those incubated in a sterile environment. Additionally, the data suggests that 2 mM indole reduces corrosion by 2-fold in the presence of DvH (MIC) compared to the no indole treatment, and that this reduction in weight loss is not replicated in a sterile environment without DvH inoculation. Therefore, the experiment demonstrates that indole's inhibitory effect on corrosion is MIC-specific.

### Example 2

### Microbial Induced Corrosion (MIC) by DvH is Reduced by Different Indole Concentrations

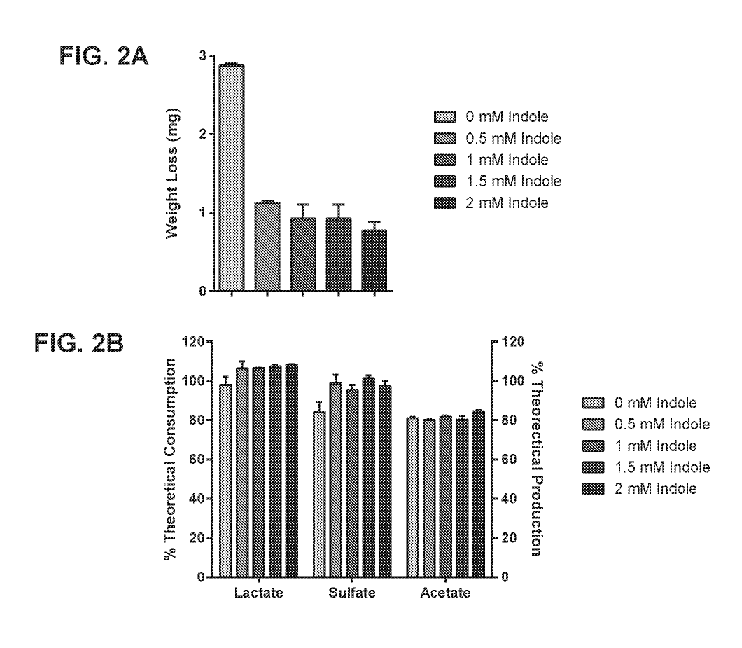

Steel coupons were incubated in cultures of DvH for three days with and without indole and then the coupons were measured to determine the amount of metal loss due to corrosion. FIG. 2A is a bar graph showing that the coupons incubated in the absence of indole resulted in nearly 2-fold more metal loss than the coupons grown in the presence of 0.5-2 mM indole. FIG. 2B is a bar graph demonstrating that the metabolism of DvH as measured by the consumption of lactate and sulfate and the production of acetate is not significantly affected by the presence of 0.5-2 mM indole. The error bars represent the standard error of the mean from 2 replicates. Thus, the data demonstrates that the metal coupons in the presence of 0.5 to 2 mM indole displayed little to no corrosion. Therefore, the experiment demonstrates that indole inhibits corrosion of metal caused by anaerobic biofilms formed from sulfate reducing bacteria.

### Bacterial Cultivation

The wild-type D. vulgaris Hildenborough (DvH) was obtained from Judy Wall at the University of Missouri and Adam Deutchbauer at the Lawrence Berkeley National Laboratory. Freezer stocks of DvH containing 10% glycerol were used to inoculate overnight cultures. The growth media (L30S30B2) contained 30 mM lactate, 30 mM sulfate, 8 mM MgCl₂, 20 mM NH₄Cl, 2.2 mM phosphate buffer, 0.6 mM CaCl₂, 24 mM NaCO₃, 0.02% resazurin, 0.06 mM FeCl₂, trace elements and Thauer's vitamins (Lee et al., “Indole as an intercellular signal in microbial communities,” 2010, pp. 426-444) with pH adjusted to 7.2. Media was bubbled with 15% CO₂ balance N₂ and sodium dithionite was added immediately before inoculation to a final concentration of 1.5 MM. Media containing 0-4 mM indole was made by anaerobically mixing varied volumes of L30S30B2 and L30S30B2 supplemented with 4 mM indole (Sigma-Aldrich, 13408).

### Carbon Steel Coupon Weight Loss Analysis

Rectangular X52 carbon steel coupons were polished on 600 grit sand paper and weighed prior to the experiment. 60 ml of L30S30B2 media containing 0-2 mM indole was anaerobically transferred into each autoclaved serum bottle with 1 coupon hung on plastic fishing wire. 1 ml of a DvH overnight culture was inoculated into each bottle and incubated at 30° C. with gentle shaking for 3 days. After the incubation the coupons were descaled with Clarke's solution (tin choloride and antimony oxide in concentrated hydrochloric acid), rinsed with water, dried under nitrogen gas, and weighed again. The metal weight loss after exposure to DvH was then calculated.

Ion Chromatography (IC)—One milliliter of cultures were extracted at the beginning and the end of the experiment, centrifuged at 14000 rpm for 2 min, filtered through 0.2 μm cellulose acetate filters, and kept at −20° C. until further IC analysis. Anions of lactate, sulfate, and acetate were quantified using suppressed conductivity on a Dionex ICS-5000 Reagent-Free HPIC System with a Dionex IonPac AS 11-HC column (0.4 mm×250 mm, Thermo Fisher, Massachusetts, USA). The temperatures for the column and the conductivity detector were maintained at 30° C. and 20° C., respectively. The following multi-step potassium hydroxide gradient was created by a Dionex EG Fluent Generator and delivered at a flow rate of 1 ml/min: 1.1 mM for 8 min, 28 mM in 6 min, hold 28 mM for 5 min, and hold 1.1 mM for 3 min.

### Example 3

### Treatment of Oil Field Pipeline with Indole to Inhibit Microbial Influenced Corrosion and Associated Biofilm Formation

Steel pipelines are used to transport seawater from treatment and pumping facilities to oil field water injection wells. The water is injected into specific regions of an oil-producing reservoir to provide secondary oil recovery. This provides additional oil recovery over that which results from primary, or natural, production due to the initial pressurization of the reservoir.

Treatment of the seawater prior to entering the pipeline is required to prevent corrosion of the steel pipeline and the steel tubing in the water injection wells and to improve injected water quality. The treatment process includes chlorination, filtration, deaeration, and addition of a solution of indole or an functional equivalent indole analog or derivative. The chlorination kills, via oxidation, the majority of the bacteria and algae entering the system with the water from the sea. The filtration removes most of the sea sediments, large particles, and biomass. Deaeration of the water is critical to remove oxygen, a key element involved in the corrosion process. Deaeration of the seawater to less than about 20 ppb oxygen essentially eliminates the potential for common oxygen-induced corrosion. Unfortunately, removing the oxygen results in an anaerobic environment, which increases the potential for anaerobic corrosion of the steel pipeline due to the activity of sulfate-reducing bacteria in the system and other categories of bacteria. Addition of a solution of indole (or functionally equivalent analog thereof) will be introduced to control the activity of the corrosion-inducing sulfate-reducing bacteria and other biofilm forming bacteria that lead to corrosion, such as iron oxidizing bacteria, sulfur oxidizing bacteria, nitrate reducing bacteria, methanogens, and acid producing bacteria, among others.

Treatment of the seawater with soluble indole (or functionally equivalent analog thereof) in this embodiment will be performed downstream of all other processes in the seawater treatment plant. The indole solution will be stored in a nitrogen-inerted (oxygen-free) feed tank connected to the suction-side of a variable-rate injection pump. This pump will be connected to the pipeline with standard connecting lines and valves, on the discharge-side of the mainline seawater pumps. A flow meter will be used to indicate the volumetric rate of injection of the soluble indole. A check valve will be located between the indole-solution pump and the pipeline to prevent seawater from flowing back into the indole-solution feed tank.

A ten-mile long, 60-inch internal diameter pipeline transports 1 million barrels of water per day from the treatment plant to an intermediate injection facility. The average seawater velocity is 3.3 ft/sec, and the flow is clearly turbulent with the Reynolds Number being 1.5×10⁶.

Prior to initiating treatments in this pipeline with the indole solution, significant corrosion of the steel pipeline will be observed. Corrosion rate and presence of corrosion in the pipeline will be determined by internal flush mounted corrosion coupons, by thru-wall ultrasonic and radiographic inspections, and by various types of internally-transported ‘smart’ pigs. Inspection of corrosion coupons removed from the pipeline after four-months of contact with the flowing water without indole treatments will indicate an average corrosion rate of 5 mils per year (0.127 mm/yr.). In addition, small pits will present which are characteristic of microbial corrosion. The other non-destructive inspection techniques will confirm that overall corrosion rate is low, but that deep pits (maximum depth up to 0.1 inch and 0.2 inch in circumference) are prevalent in certain areas of the pipeline. Both isolated pits and linked pits will be found, especially on the bottom of pipeline near girth welds. These pits are characteristic of those attributed to microbially-influenced corrosion.

In addition, analysis of internally-mounted metal coupons will indicate the presence of about 5×10⁵ sulfate-reducing bacteria cells per cm² of surface and 2×10⁴ cells per cm² of other bacteria types. The presence of an ongoing corrosion process can also be inferred by a high level of soluble ferrous ions and iron sulfide solids in the effluent water. For example, 80 ppb soluble iron and no detectable solid iron sulfides are typically found in the influent water. However, 800 ppb soluble iron and 250 ppb equivalent iron as a solid can be found in the effluent. The iron sulfide forms by the reaction of ferrous ions and sulfide ions near the surface of the pipe as the corrosion process removes ferrous ions from the steel. No sulfide is contained in the influent water. The sulfide is produced within the pipeline as a metabolic product of sulfate-reducing bacteria activity. Much of the formed iron sulfide, which is a solid, remains on the surface of the pipeline, but some is swept off by the flowing water. The total measurable iron represents a loss of 120,000 pounds of iron per year removed from the steel pipeline, or a corrosion rate of 3.6 mils per year (0.093 mm/yr). The total sulfide associated with the solid iron sulfide in the effluent water represents 19,000 pounds of hydrogen sulfide produced per year.

An indole solution will contain 10 wt. % active indole (or functionally equivalent analog or derivative) and will have a density of 10 pounds per gallon. The active indole can be solubilized to help increase the effectiveness of transport of the active indole down the pipeline and into the biofilm on the pipe wall. Soluble indole solution can be injected as a slug into the pipeline twice per month for thirty minutes at a rate of 36 gallons per minute, yielding a concentration of 150 ppm by weight of active indole in the thirty-minute slug of flowing seawater. The injected indole can affect the seawater pH within the slug.

After four months of twice per month soluble indole injections, the corrosion coupons will be measured and will indicate that the corrosion rate is reduced to less than 1 mil per year and pitting is minimal. Radiographic inspections of heavily corroded sites will indicate that minimal corrosion has occurred since the last inspection four months previously. Total iron concentrations (solid and insoluble) in water effluent samples taken 48 hours following a treatment are 120 ppb, will indicate at least a 95% reduction in. iron loss from the pipe. The sulfide associated with the effluent iron sulfide particles is reduced comparably. The concentrations of both the iron and the sulfide in effluent water increases slowly with time during the semi-monthly treatment periods such that the total iron concentration at the end of the period averages about 380 ppb. All of these monitoring techniques will confirm that injections of soluble indole (or a functionally equivalent analog thereof) into the flowing seawater effectively mitigate anaerobic microbially influenced corrosion of the steel pipeline and maintain minimal iron sulfide solids formation.

### REFERENCES

The following references are incorporated herein by reference.

Martino P D, Fursy R, Bret L, Sundararaju B, Phillips R S (2003) Indole can act as an extracellular signal to regulate biofilm formation of Escherichia coli and other indole-producing bacteria. Can J Microbiol 49: 443-449.

Lee J, Jayaraman A, Wood T K (2007) Indole is an inter-species biofilm signal mediated by SdiA, BMC Microbiolology 7.

Rant J S, Shinde R B, Karuppayil M S (2012) Indole, a bacterial signaling molecule, exhibits inhibitory activity against growth, dimorphism and biofilm formation in Candida albicans. African Journal of Microbiology Research 6: 6005-6012,

### INCORPORATION BY REFERENCE

All documents cited or referenced herein and all documents cited or referenced in the herein cited documents, together with any manufacturer's instructions, descriptions, product specifications, and product sheets for any products mentioned herein or in any document incorporated by reference herein, are hereby incorporated by reference, and may be employed in the practice of the disclosure.

### EQUIVALENTS

Those skilled in the art will recognize, or be able to ascertain using no more than routine experimentation, many equivalents to the specific embodiments and methods described herein. Such equivalents are intended to be encompassed by the scope of the following claims.

It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

What is claimed:

1. A method for mitigating or eliminating Microbial Influenced Corrosion of a metal surface comprising contacting the metal surface with an effective amount of a liquid composition comprising indole or a functionally equivalent analog or derivative thereof.

2. The method of claim wherein the Microbial Influenced Corrosion is caused by a bacterial biofilm deposited on the surface of the metal surface.

3. The method of claim 2, wherein the bacterial biofilm is formed by anaerobic bacteria.

4. The method of claim 3 wherein the anaerobic bacteria are selected from the group consisting of sulfate reducing bacteria, iron oxidizing bacteria, sulfur oxidizing bacteria, nitrate reducing bacteria, methanogens, and acid producing bacteria.

5. The method of claim 4, wherein the sulfate reducing bacteria is of the genera Desulfovibrio, Desulfotomaculum, Desulfosporomusa, Desulfosporosinus, Desulfobacter, Desulfobacterium, Desulfobacula, Desulfobotulus, Desulfocella, Desulfococcus, Desulfofaba, Desulfofrigus, Desulfonema, Desulfosarcina, Desulfospira, Desulfotalea, Desulfotigmum, Desulfobulbus, Desulfocapsa, Desulfofustis, Desulforhopalis, Desulfoarculus, Desulfobacca, Desulfomonile, Desulfotigmum, Desulfohalobium, Desulfomonas, Desulfonatronovibrio, Desulfomicrobium, Desulfonatronum, Desulfacinum, Desulforhabdus, Syntrophobacter, Syntrophothermus, Thermaerobacter, and Thermodesulforhabdus.

6. The method of claim 4, wherein the sulfate reducing bacteria is of the genus Desulfovibrio.

7. The method of claim 1, wherein the metal surface is a metal surface of equipment for refining, storing, or transporting of crude or processed oil.

8. The method of claim 1, wherein the metal surface is a metal surface of equipment for refining, storing, or transporting of natural gas.

9. The method of claim 1, wherein the liquid composition comprising indole or a functionally equivalent analog or derivative thereof is an aqueous composition.

10. The method of claim 1, wherein the liquid composition comprising indole or a functionally equivalent analog or derivative thereof is a non-aqueous composition.

11. The method of claim 1, wherein the liquid composition comprising indole or a functionally equivalent analog or derivative thereof has an acidic pH.

12. The method of claim 1, wherein the liquid composition comprising indole or a functionally equivalent analog or derivative thereof has a basic pH,

13. The method of claim 1, wherein the liquid composition comprising indole or a functionally equivalent analog or derivative thereof comprises at least one other inhibitor of Microbial influenced Corrosion.

14. The method of claim 13, wherein the at least one other inhibitor is a biocide selected from the group consisting of germicides, antibiotics, antibacterials, antivirals, antifungals, antiprotozoals and antiparasites.

15. The method of claim 1, further comprising a secondary treatment for mitigating or eliminating Microbial Influenced Corrosion of the metal surface selected from the group consisting of pigging, radiation treatment, pH adjustment, nutrient adjustment, and installation of corrosion-resistant metals.

16. The method of claim 1, wherein the effective amount of the liquid composition comprising indole or a functionally equivalent analog or derivative thereof provides a concentration of indole that is between about 5-50 ppm (50-500 micromolar), about 50-100 ppm (0.5-1.0 mM), about 100-500 ppm (1.0 mM-5 mM), about 250-1000 ppm (2.5 mM-10 mM), about 500-2500 ppm (5 mM-25 mM), or about 1000-10000 ppm (10 mM-100 mM).

17. A method for reducing the formation or activity of a corrosion-associated biofilm on a metal surface comprising contacting the metal surface with an effective amount of a liquid composition comprising indole or a functionally equivalent analog or derivative thereof.

18. The method of claim 17, wherein the corrosion-associated biofilm is formed by anaerobic bacteria.

19. The method of claim 18, wherein the anaerobic bacteria are selected from the group consisting of sulfate reducing bacteria, iron oxidizing bacteria, sulfur oxidizing bacteria, nitrate reducing bacteria, methanogens, and acid producing bacteria.

20. The method of claim 19, wherein the sulfate reducing bacteria is of the genera Desulfovibrio, Desulfotomaculum, Desulfosporomusa, Desulfosporosinus, Desulfobacter, Desulfobacterium, Desulfobacula, Desulfobotulus, Desulfocella, Desulfococcus, Desulfofaba, Desulfofrigus, Desulfonema, Desulfosarcina, Desulfospira, Desulfotalea, Desulfotigmum, Desulfobulbus, Desulfocapsa, Desulfofustis, Desulforhopalis, Desulfoarculus, Desulfobacca, Desulfomonile, Desulfotigmum, Desulfohalobium, Desulfomonas, Desulfonatronovibrio, Desulfomicrobium, Desulfonatronum, Desulfacinum, Desulforhabdus, Syntrophobacter, Syntrophothermus, Thermaerobacter, and Thermodesulforhabdus.

21. The method of claim 20, wherein the sulfate reducing bacteria is of the genus Desulfovibrio.

22. The method of claim 17, wherein the metal surface is a metal surface of equipment for refining, storing, or transporting of crude or processed oil.

23. The method of claim 17, wherein the metal surface is a metal surface of equipment for refining, storing, or transporting of natural gas.

24. The method of claim 17, wherein the liquid composition comprising indole or a functionally equivalent analog or derivative thereof is an aqueous composition.

25. The method of claim 17, wherein the liquid composition comprising indole or a functionally equivalent analog or derivative thereof is a non-aqueous composition.

26. The method of claim 17, wherein the liquid composition comprising indole or a functionally equivalent analog or derivative thereof has an acidic pH.

27. The method of claim 17, wherein the liquid composition comprising indole or a functionally equivalent analog or derivative thereof has a basic pH.

28. The method of claim 17, wherein the liquid composition comprising indole or a functionally equivalent analog or derivative thereof has a neutral pH.

29. The method of claim 17, wherein the liquid composition comprising indole or a functionally equivalent analog or derivative thereof comprises at least one other inhibitor of a corrosion-associated biofilm.

30. The method of claim 29, wherein the at least one other inhibitor is a biocide selected from the group consisting of germicides, antibiotics, antibacterials, antiviral s, antifungals, antiprotozoals and antiparasites.

31. The method of claim 17, further comprising a secondary treatment for reducing the formation or activity of a corrosion-associated biofilm on a metal surface selected from the group consisting of pigging, radiation treatment, pH adjustment, nutrient adjustment, and installation of corrosion-resistant metals.

32. The method of claim 17, wherein the effective amount of the liquid composition comprising indole or a functionally equivalent analog or derivative thereof provides a concentration of indole that is between about about 5-50 ppm (50-500 micromolar), about 50-100 ppm (0.5-1.0 mM), about 100-500 ppm (1.0 mM-5 mM), about 250-1000 ppm (2.5 m1\4-10 mM), about 500-2500 ppm (5 mM-25 mM), or about 1000-10000 ppm (10 mM-100 mM).
